(19) United States
(12) Patent Application Publication
(10) Pub. No.: US 2025/0348396 A1
(43) Pub. Date: Nov. 13, 2025

(54) METHOD OF MONITORING A DATA FLOW

(71) Applicant: Robert Bosch GmbH, Stuttgart (DE)

(72) Inventors: Emily Ruppel, Pittsburgh, PA (US); Arne Hamann, Ludwigsburg (DE); Dakshina Narahari Dasari, Renningen (DE)

(21) Appl. No.: 19/203,777

(22) Filed: May 9, 2025

(30) Foreign Application Priority Data
May 13, 2024 (DE) 10 2024 204 384.2

(51) Int. Cl. G06F 11/30; G06F 8/41

(52) U.S. Cl. CPC G06F 11/302; G06F 8/44

(57) ABSTRACT

A method of monitoring a data flow in a plurality of executed application programs. At least some application programs of the plurality of application programs are programmed in different programming languages. The method includes: transforming a program code of each application program of the plurality of application programs to a specified binary instruction format code, inserting a data flow monitoring code in the specified binary instruction format code into each transformed application program to generate a plurality of extended transformed application programs in the specified binary instruction format code, and executing the plurality of extended transformed application programs and thereby monitoring the data flow in the plurality of extended transformed application programs using the respectively inserted data flow monitoring code.

### CROSS REFERENCE

The present application claims the benefit under 35 U.S.C. § 119 of German Patent Application No. DE 10 2024 204 384.2 filed on May 13, 2024, which is expressly incorporated herein by reference in its entirety.

### FIELD

The present invention generally relates to methods for monitoring a data flow, and in particular to methods for monitoring a data flow in the context of distributed application programs.

### BACKGROUND INFORMATION

Distributed application programs include multiple application programs, also called program modules. Each program module maintains an internal state and communicates with other program modules via messages. In a distributed setting, data flows capture the progression of information from one variable to another across program modules and within individual program modules. In the case of cyber-physical systems, data flows are often described in terms of cause-effect chains, i.e., the data flow from an initial cause, such as, e.g., a sensor reading, to a final effect, such as, e.g., an actuator movement. The monitoring and tracking of such data flows is useful for debugging a distributed program and becomes critical when assessing real-time applications where cause-effect chains must meet stringent timing requirements. The challenge for monitoring data flows of distributed program applications lies in the real-time, heterogeneous, and distributed nature of real-time distributed systems.

In view of the above, efficient approaches and methods allowing real-time monitoring of data flows of distributed application programs are desirable.

### SUMMARY

In various embodiments of the present invention, methods of monitoring a data flow in a plurality of (executed) application programs, wherein at least some application programs of the plurality of application programs are programmed in different programming languages, are provided.

According to an example embodiment of the present invention, a method of monitoring a data flow in a plurality of executed application programs, wherein at least some application programs of the plurality of application programs are programmed in different programming languages includes: transforming a program code of each application program of the plurality of application programs to a specified binary instruction format code, inserting a data flow monitoring code in the specified binary instruction format code into each transformed application program to generate a plurality of extended transformed application programs in the specified binary instruction format code, and executing the plurality of extended transformed application programs and thereby monitoring the data flow in the plurality of extended transformed application programs using the respectively inserted data flow monitoring code.

Further example embodiments of the present invention are described in the following.

A method of monitoring a data flow in a plurality of executed application programs, wherein at least some application programs of the plurality of application programs are programmed in different programming languages, the method including transforming a program code of each application program of the plurality of application programs to a specified binary instruction format code, inserting a data flow monitoring code in the specified binary instruction format code into each transformed application program to generate a plurality of extended transformed application programs in the specified binary instruction format code, and executing the plurality of extended transformed application programs and thereby monitoring the data flow in the plurality of extended transformed application programs using the respectively inserted data flow monitoring code. The method mentioned in this paragraph provides a first example.

The monitored data flow may be a cause-effect chain starting from a sensor input and finishing at an actuator output. The features mentioned in this paragraph in combination with the first example provide a second example.

The specified instruction format code may be a stack-based format code. The features mentioned in this paragraph in combination with any one of the first example to second example provide a third example.

The specified instruction format code may be a WebAssembly (WASM) binary code. The WebAssembly (WASM) binary code may provide a lightweight virtualization. The features mentioned in this paragraph in combination with any one of the first example to third example provide a fourth example.

The method may further include that the (extended transformed) application programs may be configured to communicate between each other via communication channels configured according to a publish-subscribe messaging protocol, wherein, for each (extended transformed) application program, reading from a communication channel pulls a message from another (extended transformed) application program, and writing to a channel sends a message from the (extended transformed) application program. The features mentioned in this paragraph in combination with any one of the first example to fourth example provide a fifth example.

The publish-subscribe messaging protocol may be a publish-subscribe machine to machine network protocol. The features mentioned in this paragraph in combination with the fifth example provide a sixth example.

The publish-subscribe messaging protocol may be the MQTT protocol. The features mentioned in this paragraph in combination with any one of the first example to sixth example provide a seventh example.

The method may further include a plurality of computers, wherein each computer includes one or more (extended transformed) application programs, and the monitoring of the data flow may include the monitoring of inter-computers communication channels and intra-computers communication channels, wherein said communication channels are configured according to a publish-subscribe messaging protocol. The features mentioned in this paragraph in combination with any one of the first example to seventh example provide an eighth example.

The method may further include that the computers are Electronic Control Units, ECUs. The features mentioned in this paragraph in combination with the eight example provide an ninth example.

The method may further include that inserting a data flow monitoring code in the specified binary instruction format code into each transformed application program includes adding into a transformed application program one or more instructions in the specified binary instruction format code including one or more communication channel read/writes operations, wherein the one or more communication channels are configured according to a publish-subscribe messaging protocol. The features mentioned in this paragraph in combination with any one of the first to ninth example provide a tenth example.

The method may further include an orchestrator configured to receive data flow monitoring information from the extended transformed application programs, to monitor the execution of the extended transformed application programs and to receive application program execution requests, any may further include communicating between extended transformed application programs and/or between extended transformed application programs and the orchestrator via communication channels, wherein the communication channels are configured according to a publish-subscribe messaging protocol. The features mentioned in this paragraph in combination with any one of the first example to tenth example provide a eleventh example.

The method may further include that for each extended transformed application program, the data flow monitoring information includes at least one of the following: a time of arrival of one or more inputs received by the extended transformed application program, a time at which the extended transformed application program has returned one or more outputs, a record of the received inputs that have affected one or more outputs of the extended transformed application program, in case of an error of the extended transformed application program, an indication of an error cause, and an indication of a failure probability of the extended transformed application program. The features mentioned in this paragraph in combination with the eleventh example provide an twelfth example.

The method may further include that inserting a data flow monitoring code in the specified binary instruction format code into each transformed application program includes adding into a transformed application program one or more instructions in the specified binary instruction format code to implement one or more transformed application program calls to the orchestrator. The features mentioned in this paragraph in combination with any one of the tenth to twelfth example provide a thirteenth example.

The method may further include performing, prior to the execution of the plurality of (extended transformed) application programs, a data flow analysis to determine the relationship between the inputs of the plurality of (extended transformed) application programs and the outputs of the plurality of (extended transformed) application programs, the data flow analysis including determining external inputs and external outputs of the data flow, determining intra-application programs data flows for two or more (extended transformed) application programs out of the plurality of (extended transformed) application programs, and generating a set of possible (extended transformed) application programs inputs and outputs for each of the plurality of (extended transformed) application programs. The features mentioned in this paragraph in combination with any one of the first example to thirteenth example provide a fourteenth example.

The method may further include at least one of the following: determining if each external output has a continuous data flow starting at an external input, thereby generating an error in case an external output does not have a continuous data flow starting at an external input, determining, for each (extended transformed) application program, if each output has a data flow deriving from an input, determining, for each (extended transformed) application program, if every output remains defined in the case of early termination of the (extended transformed) application program, and checking if defined communication channel connections between (extended transformed) application programs are correct, wherein communication channels between (extended transformed) application programs are configured according to a publish-subscribe messaging protocol. The features mentioned in this paragraph in combination with the fourteenth example provide a fifteenth example.

The method may further include that the data flow monitoring is performed in real-time during the execution of the plurality of (extended transformed) application programs. The features mentioned in this paragraph in combination with any one of the first example to fifteenth example provide a sixteenth example.

A device may be configured to perform a method of any one of the first example to sixteenth example. The features mentioned in this paragraph provide a seventeenth example.

A computer program may have program instructions that are configured to, when executed by one or more processors, to make the one or more processors perform the method according to one or more of the first example to sixteenth example. The features mentioned in this paragraph provide a eighteenth example.

The computer program may be stored in a computer-readable storage medium. The computer-readable medium may include transitory or non-transitory data representing instructions arranged to cause a computer and/or a computer system to perform the method according to one or more of the first example to sixteenth example. The features mentioned in this paragraph provide an nineteenth example.

In the figures, similar reference characters generally refer to the same parts throughout the different views. The figures are not necessarily to scale, emphasis instead generally being placed upon illustrating the principles of the present invention. In the following description, various aspects of the present invention are described with reference to the figures.

### BRIEF DESCRIPTION OF THE DRAWINGS

FIG. 1 shows a flowchart illustrating a method for compiling and instrumenting application programs according to various embodiments;

FIG. 2 shows an exemplary inter-application program and inter-Electronic Control Unit, ECU, data flow;

FIG. 3 shows a distributed system software architecture according to various embodiments;

FIG. 4 shows an exemplary intra-application program data flow;

FIG. 5 shows an exemplary inter-application program, intra-ECU data flow;

FIG. 6 shows an exemplary inter-ECU data flow; and

FIG. 7 shows a flowchart illustrating a method of monitoring a data flow in a plurality of executed application programs according to an embodiment.

### DETAILED DESCRIPTION OF EXAMPLE EMBODIMENTS

The following detailed description refers to the figures that show, by way of illustration, specific details and aspects of this disclosure in which the present invention may be practiced. Other aspects may be utilized and structural, logical, and electrical changes may be made without departing from the scope of the present invention. The various aspects of this disclosure are not necessarily mutually exclusive, as some aspects of this disclosure can be combined with one or more other aspects of this disclosure to form new aspects.

Data flow monitoring in real-time, distributed systems has been performed using several methods, such as for example distributed (request) tracing and cause-effect chain analysis.

Distributed (request) tracing for distributed systems enables to track the requests passing between microservices, e.g. http requests passed between pieces of the application, and builds a timeline of all of the microservices that were triggered. This approach thus allows developers to understand which portions of their application program, i.e. services or functions, are consuming execution time.

However distributed tracing is only able to observe a system during execution at a high (microservice) level, and is not suited to root out the many problems encountered by distributed applications programs, in particular in cyber-physical distributed systems such as e.g. industrial automation or automotive software and systems. In distributed cyber-physical systems, it is necessary to go down to the instruction level and the timing constraints are typically much stricter than at the microservice level.

Cause-effect chains are chains/sequences of events in a system where one event (the cause) triggers a subsequent event (the effect). They provide a framework for understanding the complex relationships and dependencies between the various components and processes in a distributed system including a plurality of application programs.

By using cause-effect chains to compute end-to-end timing, bottlenecks and areas where the system can be optimized are identified. This information may also be used to predict how (future) changes to the system will affect overall performance, and to identify potential risks or points of failure.

Analyzing the behavior of cause-effect chains in distributed systems can be challenging, as the chains can be very complex and spread across multiple components and/or processes.

Therefore, further techniques such as distributed data flow monitoring and analysis are used to better understand the dynamics of the system and to identify the different factors that contribute to a particular outcome. Being able to perform this analysis accurately can further help identifying timing and performance issues in distributed cause-effect chains, thus ensuring that the system is functioning correctly and efficiently.

End-to-end timing analysis of cause-effect chains typically relies on making certain assumptions about the execution time or using simulation platforms. Several models may be used for estimating the execution time, such as e.g. implicit execution time models in which the input and output of data flows entering and leaving a program module occurs at a deterministic time, logical execution time models stating that the output value from a module is available once the next period starts and/or assumptions on the execution time of program modules being fixed or bounded.

Having more knowledge of the behavior of the system will lead to a more accurate timing analysis, which is especially important in real-time distributed cyber-physical systems, which typically have very stringent timing requirements.

Therefore, being able to accurately monitor data flows and analyze attributes related not only to (program) module-to-module communication, but also to the execution times of (program) modules is critical in understanding the behavior of cause-effect chains.

Data flow monitoring in distributed systems (and in particular in cyber-physical distributed systems) therefore requires improvements to be useful in real-time distributed systems.

Various embodiments relate to providing a method to improve real-time data flow monitoring in (cyber-physical) distributed systems.

It is another aspect of the present disclosure to provide a method for both inter-and-intra program module timing analysis, since typically only one or the other is performed, but not both simultaneously/in real-time.

It is another aspect to provide hardware and programming language independence, i.e. to simultaneously provide hardware and programming language independent support for data flow checking in a distributed system.

It is another aspect to provide dynamic cause-effect chain analysis, i.e. to support cause-effect chain analysis where program modules can be dynamically added or removed from the distributed system.

It is another aspect to provide a framework for data flow monitoring that allows dynamic adaptation of the monitoring logic at runtime, i.e. without having to shut down and restart the entire distributed system.

In the following, various examples will be described in more detail.

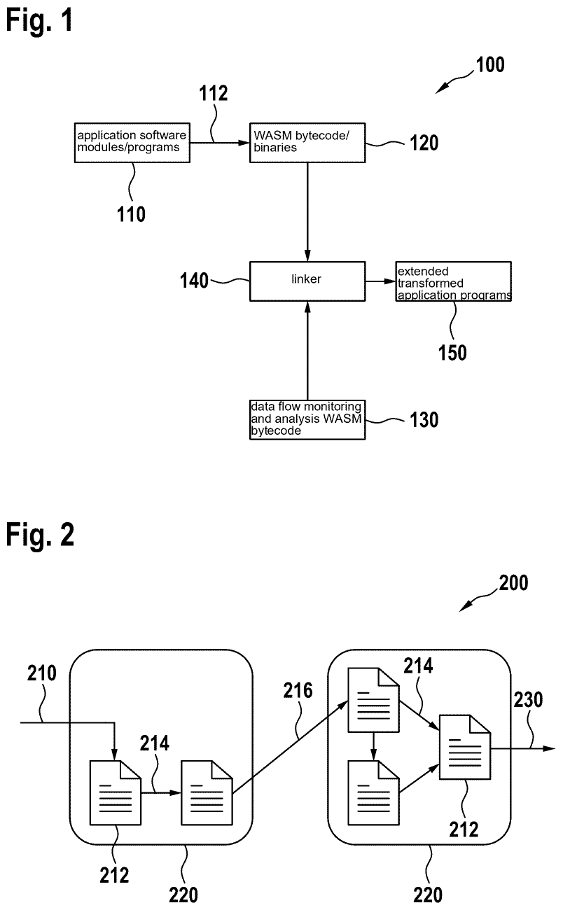

FIG. 1 shows a flowchart 100 illustrating a method for compiling and instrumenting (distributed) application programs according to various embodiments.

In FIG: 1, a plurality of application software modules/programs 110, written in any of a number of different programming languages have their source code compiled/transformed in 112 into a same specified binary instruction format code, such as for example the WebAssembly, WASM, binary instruction format code.

In the following, WASM is used throughout as the binary instruction format code. It should however be understood by those in the art that other types of binary instruction format codes/stack-based format codes may be specified, and that the embodiments are applicable to other types of codes.

WASM is a technology originally developed for the web that defines a stack-based virtual machine with static types, structured control flow, and a linear memory. The program code, written in any of a number of languages, is first compiled to a WASM binary and then compiled into a machine-specific instruction set of the platform the code will run on.

Further, the WebAssembly Component model allows programmers to seamlessly integrate applications written in different programming languages. This feature is important for dynamic program analysis because it means the code-under-test and the analysis code do not need to be written in the same programming language. Thus, performing program analysis with WASM (binaries) allows the same debugging infrastructure to be reused for many different programming languages and different hardware platforms.

Using WASM binaries further allows a lightweight virtualization, i.e. it is not necessary to emulate the entire hardware environment, thus requiring less hardware resources. It should be noted that this may apply to other types of program code/binaries used as binary instruction format code.

After the plurality of application programs 110 written in different programming languages have been compiled and transformed in 112 into application WASM bytecode/binaries 120 (transformed application programs 120), allowing for a compact and portable representation of the original application programs (software modules) 110.

A data flow monitoring and analysis WASM bytecode 130 is added via a linker 140 to the application WASM bytecode 120, wherein the linker is configured to connect bytecodes written in different source languages via the WASM component model.

This results in an instrumented WASM bytecode 150 (extended transformed application programs 150), which is thus application programs with added extra code to allow/facilitate data flow monitoring.

The instrumented WASM bytecode 150 may then be further transformed and/or compiled and/or deployed to be able to run on different hardware platforms (not shown in FIG. 1).

FIG. 2 shows an exemplary inter-application program and inter-Electronic Control Unit, ECU, data flow 200.

FIG. 2 illustrates an exemplary cause-effect chain of a distributed cyber-physical system.

It should be understood by those in the art that other type of publish-subscribe message protocols/systems may be specified, and that the embodiments are applicable to other types of publish-subscribe message protocols/systems.

It should be noted that the use of one or more ECUs in the following is exemplary, and that the embodiments are applicable to any computer (system) connected to (input) sensors and (output) actuators.

In FIG. 2, an external sensor input 210, such as e.g. from a temperature sensor, proximity sensor, pressure sensor, touch sensor, motion sensor, ultrasound sensor, accelerometer, humidity sensor, infrared sensor, camera, radar, LiDAR, etc., is received by an application program (application module) 212.

In the example of FIG. 2, application program 212 is an instrumented WASM bytecode program, such as e.g. instrumented WASM bytecode 150.

The sensor input 210 is then processed by application program 212, generating an output. The generated output is then communicated/transmitted via communication link 214 to one or more further application programs 212, which are instrumented WASM bytecode programs, such as e.g. instrumented WASM bytecode 150.

In the example of FIG. 2, the two application programs 212 form (and/or are a part of) an Electronic Control Unit, ECU, 220 (computer/computer system). Further application programs (not shown in FIG. 2) may also be part of (first) ECU 220.

Any communication 214 between application programs within an ECU 220 are considered to be intra-ECU communications. The application programs may for example communicate via a publish-subscribe messaging protocol with each other.

The (first) ECU 220 may also communicate with one or more further ECUs 220 (i.e. with an application program located in a different ECU) via an inter-ECU communication link 216. The further ECUs 220 each also includes one or more application programs 212, such as e.g. instrumented WASM bytecode 150, that communicate with each other via communication links 214.

At the end of the cause-effect chain an application program 212 generates an output which is then used to actuate an actuator 230, such as e.g. a mechanical, pneumatic, hydraulic, electric, thermal, rotary, etc., actuator.

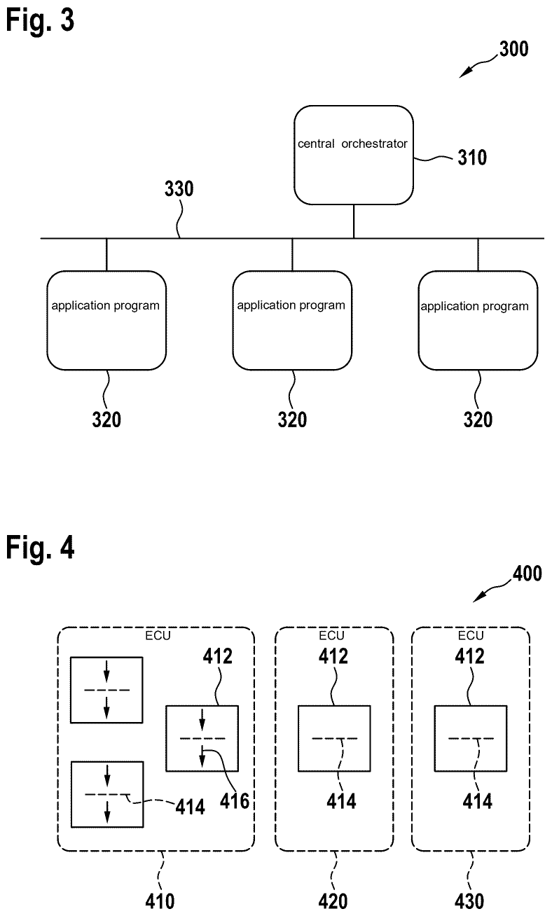

FIG. 3 shows a distributed system software architecture 300 according to various embodiments.

In FIG. 3, a plurality of application programs 320 in WASM binary code, such as e.g. application programs 212 and 150, communicate via communication channels, such as e.g. communication channels 214 and 216, with each other via a publish-subscribe machine to machine network protocol 330, e.g. the MQTT protocol.

It should be understood by those in the art that other type of publish-subscribe message protocols/systems may be specified, and that the embodiments are applicable to other types of publish-subscribe message protocols/systems.

The plurality of application programs 320 also communicate via communication channels and protocol 330 with a centralized orchestrator 310.

The centralized orchestrator 310 observes and manages the deployment of the program applications (modules). The orchestrator 310 can react in real-time/at runtime to information provided/revealed by the data flow monitoring in order to improve the system performance.

To reduce the overhead and delay of the orchestrator's 310 operations, the orchestrator 310 may be configured to deploy so-called sidecar modules, i.e. WebAssembly modules that perform a control and/or analysis function directly on a compute node (e.g. deployed in an ECU such as ECU 220, not shown in FIG. 3).

The system software architecture 300 of FIG. 3 allows to easily insert static and dynamic monitoring and analysis components that provide lightweight, time-aware data flow monitoring. This provides the end-to-end data flow monitoring with a range of tools to analyze cause-effect chains in the system.

The combination of structured, channel-based communication and WASM allows to perform static and dynamic data flow integrity checking that is language and hardware agnostic. Instrumenting the WASM binary with bindings generated by the WebAssembly component model allows the analysis code to be language agnostic.

Before the application programs are deployed, a (first) static analysis pass will conservatively predict data flows from each application program's input channels to their respective output channels using a fixed-point data flow analysis. This static analysis pass serves to instrument the writes to variables that influence the output channels of a given application program, to identify end-to-end cause-effect chains that span multiple application programs, and to identify application programs outputs that are not used as inputs by other application programs.

At runtime, the analysis instrumentation is invoked allowing the monitoring and tracking of actual data flow paths by communicating locally with the programming analysis component and remotely with the (RDS) orchestrator 310.

The distributed software architecture 300 of FIG. 3 thus allows both static and dynamic connectivity/data flow monitoring and checking.

Static connectivity checking prior to runtime, i.e. prior to the execution of application programs 320, checks the connectivity between application programs (software modules) in a distributed system, i.e., the data flow between applications. This is typically defined in an application manifest.

Dynamic data flow checking allows the orchestrator 310 to add and/or remove application programs 320 (software modules) of the distributed cyber-physical system at runtime. This requires checking/confirmation that the change will not cause the system to violate any timing requirements/guarantees.

Cause-effect chains must be directed-acyclic graphs, but in a distributed system, it is difficult to verify that no cycles in the system exist. Static checking can identify possible cycles at compile time, however dynamic analysis is able to evaluate the runtime behavior, i.e. can identify which cycles will actually manifest during execution of the application programs in the distributed system.

End-to-end data flow timing monitoring and analysis at runtime further allows the central orchestrator 310 to discover data flow characteristics at runtime and to react to changes. For instance, end-to-end data flow monitoring and analysis lets the orchestrator 310 identify the most active data flows and modulate network activity to optimize for them.

With no change to the application code, further instrumentation may be added to check whether data is being read without being used (oversampled) or if tasks are reusing stale data (undersampled).

Furthermore, complex distributed application programs behave differently depending on the operating mode. For instance, depending on different context situations computational requirements may change, data flows may be activated/deactivated, input and/or output relations may change, etc. Detecting mode changes based on modifications in cause-effect chains behavior allows for mode-specific reactions and optimizations.

In the following examples of a static analysis at compile time and of a dynamic analysis at runtime are described in more details.

### Static Analysis

At (WASM) compile time, a data flow analysis pass is performed to capture the relationship between each of the application programs (application modules) inputs and outputs. The analysis for example proceeds as follows:

Read in all application programs 320 (application modules) in the system, i.e. all application programs across all compute nodes to identify the system's external inputs and outputs.

Perform a data flow analysis on each application program 320 to identify intra-program data flows (data flow 416 in FIG. 4) and generate a set of all of an application program's inputs, i.e. of all of the channel read operations, that can affect a program output, i.e., channel write operations. A data flow in this case includes a list of instructions that write to locations in memory that will be read while calculating an output value. When a value written to memory is acquired from an external input, it is considered the start of the data flow.

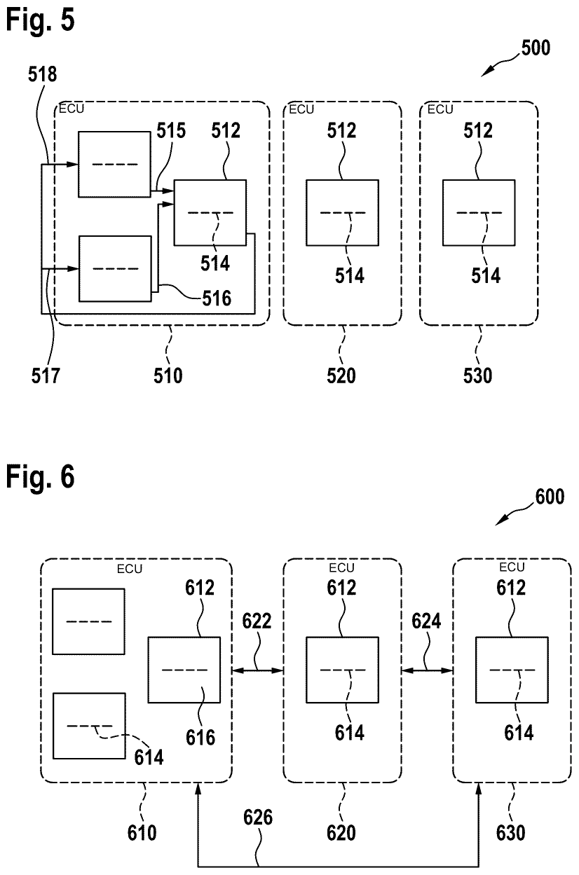

Perform a data flow analysis on the channel read/write operations of the application programs 320 in the system to generate a set of the channel write operations that may define the value seen by each channel read operation. This analysis abstracts communication channels based on the underlying semantics of the chosen publish/subscribe mechanism. Typically, a channel operation will specify the topic, the global data value, that it is writing to, so the analysis can treat each write to a topic as a data source for the next read to that topic. If topics are global across the entire system, the data flow analysis can easily derive the inter-module and inter-ECU data flow in the system (illustrated in FIG. 5 and FIG. 6). If topics are not global and are e.g. private to a given ECU, a more complicated abstraction is required to define the data flows between ECUs.

Once all of the data flows have been established, generate lists of instructions that define the data flows from the external inputs to the external outputs. Each external output has its own data flow list.

Given the lists of instructions that define data flows through the system, the static analysis may further perform at least one of the following functions:

Check for the integrity of cause-effect chains across the distributed system: For each external output, there should be at least one continuous data flow starting at an external input and culminating at the output. If this is not found for each output, the static analysis will trigger an error.

Provide warnings about incomplete data flows: For all possible control flow paths through a program/module, confirm that each output has a data flow stemming from an input. This analysis checks that an application program's outputs are always defined even in the case of early termination of the application program (e.g., error condition control flow paths).

Check or automatically generate parts of the application manifest: The application manifest defines the channel connections between application programs. The data flow analysis can check that a given application manifest is correct by confirming that the specified connections match with the data flow. Further, the analysis can also automatically generate the connection specification between application programs by reporting the identified inter-module data flows.

Selectively instrument: Selectively add instrumentation to communication channel reads/writes and instructions in the data flow with calls to the cause-effect chain monitoring framework, e.g. to centralized orchestrator 310. The instrumentation is selective because which accesses are instrumented depends on the dynamic analysis to be performed.

### Dynamic Analysis

At runtime, the centralized orchestrator 310 collects information from the data flow monitoring framework. The orchestrator 310 runs analysis modules to determine the health of the system. At runtime the instrumentation communicates with the orchestrator 310 (or supervisor sidecar, i.e. a locally executed WebAssembly module doing the monitoring) to perform the following:

Mark the time when an input arrived at an application program.

Mark the time when an output leaves an application program.

Record the inputs that affected an output, for example record which inputs the output is a function of, record what input processing slows down the generation of an output, record if one of the inputs to an output is stale.

Use data flow capture to generate a sketch of behavior when the system fails and optionally trigger relocation of programs/resources when a failure looks likely.

In the following, examples of intra-application program channel communication, inter-application program communication and inter-ECU communication are illustrated in FIG: 4, FIG. 5 and FIG. 6 respectively.

FIG. 4 shows an exemplary intra-application program (intra-program module) data flow 400.

In FIG. 4, three ECUs 410, 420 and 430, (three computers/computer systems) such as e.g. ECUs 220, each contain at least one application program 412, such as e.g. instrumented WASM bytecode 150 and/or instrumented application program 212.

For example, the first ECU 410 may include three application programs 412 with program code 414, wherein each application program 412 contains WASM bytecode.

In the following, for illustration purposes, the program code of exemplary application programs 412 (and application programs 512, 612 illustrated in FIG. 5 and FIG. 6 respectively) is shown at a higher level of programming. It is understood that this is exemplary in nature, and that this higher level program code has to be compiled/transformed into the WASM bytecode format.

For example, the three application programs may have the following program code:
1. get tire pressure ( )
channel_in (parameters)
get_pressure (parameters)
channel_out (press)
2. get tire temp ( )
channel_in (parameters)
get_temp (parameters)
channel_out (temp)
3. sanity check ( )
channel_in (press)
channel_in (temp)
if check (press, temp):
channel_out (press_ok)
channel_out (temp_ok)
else:
new_sampling_params ( )
channel_out (parameters)

In the above exemplary code, the intra-application program (module) data flow 416 follows every logical/function step of the application programs code.

For example, for the first exemplary application program “get_tire_pressure ( )”, the data flow 416 represented by a-->symbol is given by:
channel_in (parameters)-->get pressure (parameters)-->channel_out (press).

Similarly, the data flow 416 for the second exemplary application program “get_tire_temp ( )” is:
channel_in (parameters)-->get_pressure (parameters)-->
channel_out (press).

The data flow 416 for the third exemplary application program “sanity_check ( )” is:
channel_in (press)
channel_in (temp)
-->
if check (press, temp):
channel_out (press_ok) channel_out (temp_ok)
else:
new_sampling_params ( )
-->
channel_out (parameters)

FIG. 5 shows an exemplary inter-application program (inter-program module), intra-ECU data flow 500.

In FIG. 5, three ECUs 510, 520 and 530, such as e.g. ECUS 410, 420, 430 and/or ECUs 220, each contain at least one application program 512, such as e.g. instrumented WASM bytecode 150 and/or instrumented application program 212.

For example, the first ECU 510 may include three application programs 512 with program code 514, wherein each application program 512 contains WASM bytecode.

For example, the three application programs 512 may be the same as application programs 412 “get_tire_pressure ( )”, “get_tire_temp ( )” and “sanity_check (_)” of FIG. 4.

In this example, the inter-application program, intra-ECU data flows 515, 516, 517 and 518 would be the following:
Data flow 515: channel_out (press)-->channel_in (press).
Data flow 516: channel_out (temp)-->channel_in (temp).
Data flow 517: channel_out (parameters)-->channel_in (parameters) (in application program “get_tire_temp ( )”).
Data flow 518: channel_out (parameters)-->channel_in (parameters) (in application program “get_tire_pressure ( )”).

It should be noted that data flows 517 and 518 may also be combined/considered as a single data flow (not shown in FIG. 5).

FIG. 6 shows an exemplary inter-ECU data flow 600.

In FIG. 6, three ECUs 610, 620 and 630, such as e.g. ECUS 510, 520, 530, ECUs 410, 420, 430 and/or ECUs 220, each contain at least one application program 612, such as e.g. instrumented WASM bytecode 150 and/or instrumented application program 212.

For example, the first ECU 610 may include three application programs 612 with program code 614, wherein each application program 612 contains WASM bytecode.

For example, the three application programs 612 may be the same as application programs 412 “get_tire_pressure ( )”, “get_tire_temp ( )” and “sanity_check (_)” of FIG. 4.

In FIG. 6, the ECUs 610, 620 and 630 are configured to communicate with each other. This inter-ECU communication is captured by data flows 622, 624 and 626.

Application program 612 of the second ECU 620 may for example have the following exemplary program code:
calc brake force ( )
channel in (press-ok)
channel in (temp-ok)
channel in (brake_meas)
channel in (abs_plan)
calc_force (abs_plan, press-ok, temp-ok)
channel_out (brake_force)

Application program 612 of the third ECU 630 may for example have the following exemplary program code:
actuate-brake ( )
channel_in (brake_force)
apply_force (brake_force)
meas_force ( )
channel_out (brake_meas)

In this example, the inter-ECU data flows 622, 624 and 626 would be the following:
Data flow 622: channel_out (parameters)-->channel
in (press_ok) & channel-in (temp_ok).
Data flow 624: channel_out (brake force)-->(channel_in (brake_force) and
channel_out (brake_meas)-->channel_in (brake_meas).
Data flow 626: empty.

Data flow 626 is empty in the above example because the first ECU 610 and third ECU 630 do not exchange any information over the two-way communication channel in the above example.

Optionally, the application programs may also include intra-program application data flows 616.

It should further be noted that the examples of FIG. 4, FIG. 5 and FIG. 6 can be combined, i.e. intra-application program data flows, inter-application intra-ECU data flows and inter-ECU data flows. This is typically the case in real distributed cyber-physical systems.

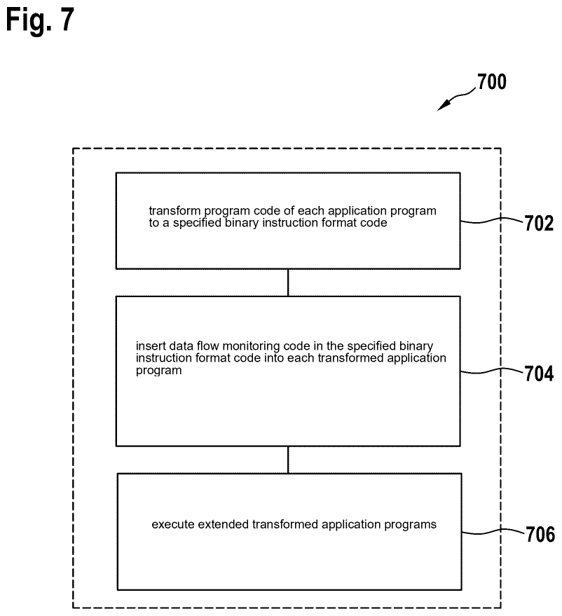

FIG. 7 shows a flowchart illustrating a method 700 of monitoring a data flow in a plurality of executed application programs according to an embodiment.

As shown in FIG. 7, the method 700 includes transforming 702 a program code of each application program of the plurality of application programs to a specified binary instruction format code, inserting 704 a data flow monitoring code in the specified binary instruction format code into each transformed application program to generate a plurality of ex-tended transformed application programs in the specified binary instruction format code, and executing 706 the plurality of extended transformed application programs and thereby monitoring the data flow in the plurality of extended trans-formed application programs using the respectively inserted data flow monitoring code.

It is appreciated that implementations of methods detailed herein are demonstrative in nature, and are thus understood as capable of being implemented in a corresponding device. It is thus understood that a device corresponding to a method detailed herein may include one or more components configured to perform each aspect of the related method.

What is claimed is:

1. A method of monitoring a data flow in a plurality of executed application programs, wherein at least some application programs of the plurality of application programs are programmed in different programming languages relative to one another, the method comprising the following steps:
transforming program code of each application program of the plurality of application programs to a specified binary instruction format code;
respectively inserting data flow monitoring code in the specified binary instruction format code into each of the transformed transformed application programs to generate a plurality of extended transformed application programs in the specified binary instruction format code; and
executing the plurality of extended transformed application programs and thereby monitoring the data flow in the plurality of extended transformed application programs using the respectively inserted data flow monitoring code.

2. The method of claim 1, wherein the monitored data flow is a cause-effect chain starting from a sensor input and finishing at an actuator output.

3. The method of claim 1, wherein the specified instruction format code is a stack-based format code.

4. The method of claim 1, wherein the specified instruction format code is a WebAssembly binary code.

5. The method of claim 1, wherein:
the extended transformed applications programs are configured to communicate between each other via communication channels configured according to a publish-subscribe messaging protocol, and
for each extended transformed application program, reading from a communication channel pulls a message from another of the extended transformed application programs, and writing to a channel sends a message from the extended transformed application program.

6. The method of claim 5, wherein the publish-subscribe messaging protocol is a publish-subscribe machine to machine network protocol.

7. The method of claim 5, wherein the publish-subscribe messaging protocol is a Message Queuing Telemetry Transport (MQTT) protocol.

8. The method of claim 1, wherein:
a plurality of computers are provided,
each computer of the plurality of computering including one or more of the extended transformed application programs, and
the monitoring of the data flow includes monitoring of inter-computer communication channels and intra-computers communication channels, the communication channels are configured according to a publish-subscribe messaging protocol.

9. The method of claim 8, wherein the respectively inserting of the data flow monitoring code in the specified binary instruction format code into each transformed application program includes:
adding into the transformed application program one or more instructions in the specified binary instruction format code including one or more communication channel read/writes operations, wherein the one or more communication channels are configured according to a publish-subscribe messaging protocol.

10. The method of claim 1, wherein an orchestrator is provided, configured to receive data flow monitoring information from the extended transformed application programs, to monitor the execution of the extended transformed application programs, and to receive application program execution requests, and wherein the method further comprises:
communicating, via communication channels: (i) between the extended transformed application programs and/or (ii) between the extended transformed application programs and the orchestrator, wherein the communication channels are configured according to a publish-subscribe messaging protocol.

11. The method of claim 10, wherein, for each of the extended transformed application programs, the data flow monitoring information includes at least one of the following:
a time of arrival of one or more inputs received by the extended transformed application program;
a time at which the extended transformed application program has returned one or more outputs;
a record of the received inputs that have affected one or more outputs of the extended transformed application program;
in case of an error of the extended transformed application program, an indication of an error cause;
an indication of a failure probability of the extended transformed application program.

12. The method of claim 10, wherein the respectively inserting of the data flow monitoring code in the specified binary instruction format code into each of the transformed application program includes:
adding into the transformed application program one or more instructions in the specified binary instruction format code to implement one or more transformed application program calls to the orchestrator.

13. The method of claim 1, further comprising the following steps:
performing, prior to the execution of the plurality of extended transformed application programs, a data flow analysis to determine a relationship between inputs of the plurality of the extended transformed application programs and outputs of the plurality of extended transformed application programs, the data flow analysis including:
determining external inputs and external outputs of the data flow;
determining intra-application programs data flows for two or more extended transformed application programs out of the plurality of extended transformed application programs; and
generating a set of possible application programs inputs and outputs for each of the plurality of extended transformed application programs.

14. The method of claim 13, further comprising at least one of the following:
determining if each external output has a continuous data flow starting at an external input, and generating an error in case an external output does not have a continuous data flow starting at an external input;
determining, for each extended transformed application program, if each output has a data flow deriving from an input;
determining, for each extended transformed application program, if every output remains defined in the case of early termination of the extended transformed application program; and
checking if defined communication channel connections between extended transformed application programs are correct, wherein the communication channels between extended transformed application programs are configured according to a publish-subscribe messaging protocol.

15. A non-transitory computer-readable medium on which are stored data representing instructions arranged to cause a computer system to perform a method of monitoring a data flow in a plurality of executed application programs, wherein at least some application programs of the plurality of application programs are programmed in different programming languages relative to one another, the method comprising the following steps:
transforming program code of each application program of the plurality of application programs to a specified binary instruction format code;
respectively inserting data flow monitoring code in the specified binary instruction format code into each of the transformed transformed application programs to generate a plurality of extended transformed application programs in the specified binary instruction format code; and
executing the plurality of extended transformed application programs and thereby monitoring the data flow in the plurality of extended transformed application programs using the respectively inserted data flow monitoring code.
